(19) United States
(12) Patent Application Publication
(10) Pub. No.: US 2010/0071202 A1
(43) Pub. Date: Mar. 25, 2010

(54) CABLE-CRIMPING TOOL FOR CONNECTORS

(75) Inventors: John Peng, Taipei County (TW); Roger Hsiung, Taipei County (TW)

Correspondence Address: VOLPE AND KOENIG, P.C., UNITED PLAZA, SUITE 1600, 30 SOUTH 17TH STREET, PHILADELPHIA, PA, 19103, US

(73) Assignees: DAN-CHIEF ENTERPRISE CO., LTD., Taipei County (TW); TOOLMART INDUSTRIAL CO., LTD., Taipei County (TW)

(21) Appl. No.: 12/360,493

(22) Filed: Jan. 27, 2009

(30) Foreign Application Priority Data
Sep. 22, 2008 (TW) 097217123

(51) Int. Cl. H01R 43/042

(52) U.S. Cl. 29/751

(57) ABSTRACT

A cable-crimping tool for connectors is provided. The cable-crimping tool comprises a connector socket having a guiding slot, a crimping and cutting element, and an arm connected with the crimping and cutting element, located on the guiding slot, and being movable along the guiding slot. The connector socket has a constraint structure, and the arm has a stopping element constrained by the constraint structure.

### FIELD OF THE INVENTION

The present invention relates to a hand tool, and more particularly to a tool for crimping a cable with a connector.

### BACKGROUND OF THE INVENTION

There exist many different ways of combining a cable with a terminal in a connector, such as winding, bundling, and welding. However, each of the above-mentioned methods has its own deficiencies for various types of electronic products searching for miniaturation, particularly for computer peripherals. Particularly, those methods are hard to be applied to the miniaturized terminals. Accordingly, under the prerequisite of physical miniaturation as well as easy manufacturing, most of the current small connectors are made by means of crimping to connect (usually electrically) the cable with the connector. With a simple press-to-fit operation, the connector is tightly combined with the cable.

However, there are usually several small connecting lines in a network cable. For example, a typical network connector comprises a socket for RJ45 modular plug at one end and an Insulation Displacement Connector (IDC) at the other end. Each conducting wire in four pairs of twisted cables is individually inserted into the IDC utilizing special punch-down tool. Consequently, there should be eight times of punching and cutting operations to complete the connection. It takes time to insert the conducting wires into the IDC one by one. Therefore, the purpose of the present invention is to have a connector electrically connected with a cable as efficient as possible and to remove redundant conducting wires, without changing specifications of the current connectors and cables. In other words, the present invention is to provide a time-saving as well as labor-saving tool design which allows the type of connector socket switchable.

### SUMMARY OF THE INVENTION

In accordance with one aspect of the present invention, a cable-crimping tool for connectors is provided. The cable-crimping tool comprises a connector socket having a guiding slot, a crimping and cutting element, and an arm connected with the crimping and cutting element, located on the guiding slot, and being movable along the guiding slot.

Preferably, the connector socket has a constraint structure, and the arm has a stopping element constrained by the constraint structure.

Preferably, the constraint structure is a hole for allowing the stopping element to cross therethrough, and the stopping element is connected to the arm.

Preferably, the constraint structure has a top dead center and a bottom dead center, and the stopping element moves therebetween.

Preferably, the tool further comprises a first handle having the connector socket, a second handle pivotally connected with the first handle, a pivot portion formed between the first and the second handles, a slider located between the first and the second handles, and including the crimping and cutting element, and a connecting rod connecting the second handle and the slider, and driving the slider to move the crimping and cutting element toward the connector socket when the first and the second handles approach to each other.

Preferably, the slider is located below the pivot portion.

Preferably, the first handle has a sliding space under the pivot portion for accommodating the slider.

Preferably, the connecting rod is pivotally connected with the second handle and the slider.

Preferably, the connecting rod is extended from a central portion of the second handle toward the pivot portion, and is connected to the slider.

Preferably, the connector socket is exchangeable.

Preferably, the tool further comprises an elastic element located between the first handle and the slider.

Besides, the tool further comprises a pivot portion having a first side and a second side opposite to the first side, a pressing rod pivotally connected with the pivot portion and having a free end, and a connecting rod having a first end connected to the crimping and cutting element, and a second end connected to the pressing rod, in which the connector socket is located at the first side of the pivot portion, and the free end is located at the second side of the pivot portion.

Preferably, the crimping and cutting element is movable in a sliding space adjacent to the pivot portion and comprises a presser and a cutter.

Preferably, the tool further comprises a main body, in which the connector socket and the pivot portion are disposed at the main body, and the crimping and cutting element is disposed at the main body in a manner of allowing the crimping and cutting element to slide.

Preferably, the main body has a holding portion under the free end of the pressing rod.

In accordance with another aspect of the present invention, a cable-crimping tool for connectors is provided. The cable-crimping tool comprises a connector socket having a constraint structure, a slider having a constraint element being movable in the constraint structure, and a crimping and cutting element allocated on the slider.

Preferably, the slider further comprises an arm extended therefrom and connected to the constraint element.

Preferably, the connector socket has a guiding slot for accommodating the arm.

In accordance with a further aspect of the present invention, a cable-crimping tool for connectors is provided. The cable-crimping tool comprises a connector socket having a constraint structure, and a crimping element having a constraint element in the constraint structure.

Preferably, the constraint structure has a top dead center and a bottom dead center, and the constraint element is moved back and forth between the top dead center and the bottom dead center.

The above objects and advantages of the present invention will become more readily apparent to those ordinarily skilled in the art after reading the details set forth in the descriptions and drawings that follow, in which:

### BRIEF DESCRIPTION OF THE DRAWINGS

FIG. 1 is a sectional view showing a cable-crimping tool for connectors, according to a preferred embodiment of the present invention;

FIG. 2 is a schematic diagram showing that the cable-crimping tool is operated and the two handles are close to each other;

FIG. 3 is a schematic diagram of the cable-crimping tool for connectors, according to the preferred embodiment of the present invention shown in FIG. 1;

FIG. 4 is a schematic diagram of the cable-crimping tool for connectors, according to another preferred embodiment of the present invention; and

FIG. 5 is a pictorial diagram showing a portion of the cable-crimping tool for connectors, according to the preferred embodiment of the present invention shown in FIG. 2.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

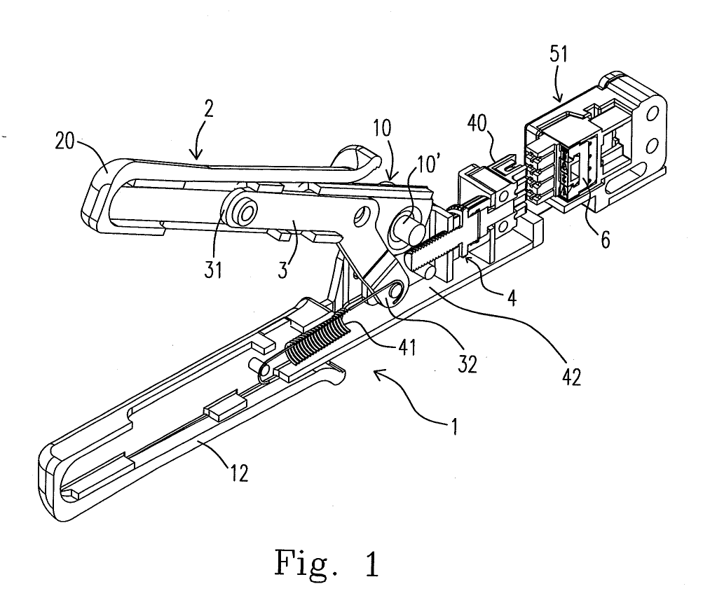

Please refer to FIG. 1, which is a sectional view showing a cable-crimping tool for connectors, according to a preferred embodiment of the present invention. FIG. 1 discloses a first handle 1 which has a connector socket 51. Usually a handling portion 12 and the connector socket 51 are located at both ends of the first handle 1 respectively, and a pivot portion 10 pivotally connected to a second handle 2 is located between the handling portion 12 and the connector socket 51. The second handle 2 is connected to a slider 4 via a connecting rod 3, in which a first end 31 of the connecting rod 3 is connected to a central portion of the second handle 2 and a second end 32 of the connecting rod 3 is connected to the slider 4. Usually the connecting rod 3 is pivotally connected with the second handle 2 and the slider 4. Besides, the slider 4 is furnished with a crimping and cutting element 40 facing the connector socket 51. When the first handle 1 and the second handle 2 approaches each other, a force is transmitted from the first end 31 of the connecting rod 3 to the second end 32 thereof, to push the slider 4 and make the crimping and cutting element 40 approach the connector socket 51. And usually a pivot 10′ is utilized for the purpose of jointing the first handle 1 and the second handle 2.

Please continue referring to FIG. 1, in which it is observed that the slider 4 is extended to a space below the pivot portion 10 for connecting to the second end 32 of the connecting rod 3, and the slider 4 is located at a sliding space 42 allowing the slider 4 to slide therein.

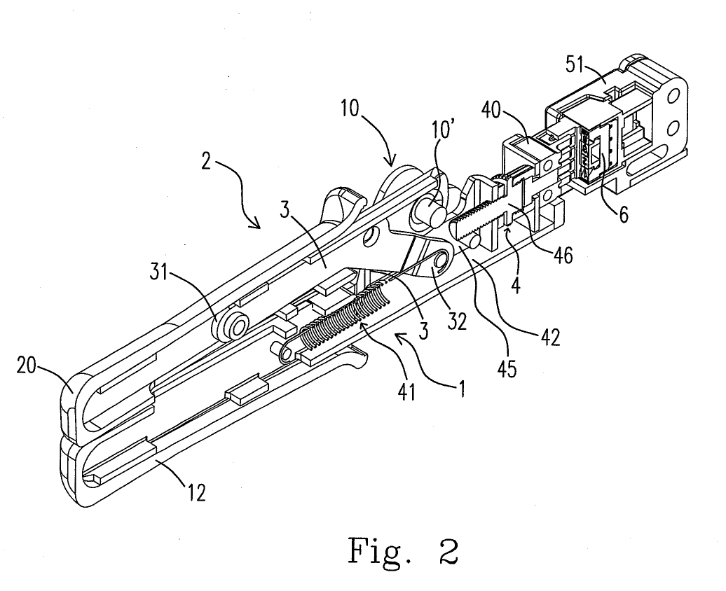

Please refer to FIG. 2, which is a schematic diagram showing that the cable-crimping tool is operated and the two handles are close to each other. It can be observed from FIG. 2 that the first handle 1 and the second handle 2 are virtually next to each other, and the connecting rod 3 pushes the slider 4 to the very front to let the crimping and cutting element 40 enter a connector 6. In such a situation, the crimping and cutting element 40 is in fact pressing the cable (not shown) into the connector 6 to allow the IDC (not shown) to cut through the insulator covering the conducting wires of the cable and to be electrically connected to the conducting wires, while a cutting portion (not shown) is cutting off and removing redundant conducting wires.

To make it convenient for the crimping operation to the next connector, the present invention further provides an elastic element 41 located between the first handle 1 and the slider 4. Usually being a spring, the elastic element 41 is used for moving the slider 4 back to its original position as shown in FIG. 1. Therefore, the elastic element 41 in FIG. 2 is in a stressed condition. In other words, the elastic element 41 in FIG. 2 is elongated. Accordingly, it is a tension spring in this case. When the force that makes the first handle 1 and the second handle 2 approach each other is removed, the elastic element 41 drives the slider 4 from the position shown in FIG. 2 back to the position shown in FIG. 1, and the slider 4 pushes the connecting rod 3 to move the second handle 2 away from the first handle 1. Consequently, there is no need to draw the second handle 2 away from the first handle 1 on purpose; it only needs to release the hand grasping the handles. Therefore, FIG. 1 shows the situation of releasing the first and the second handles 1, 2 while FIG. 2 shows the situation of holding the two handles 1, 2 together.

In addition, the slider 4 comprises a tail end 45 and an adjusting screw 46. The connecting rod 3 controls the back-and-forth movement of the slider 4 via the tail end 45 and the adjusting screw 46. And the adjusting screw 46 is used for changing the distance between the tail end 45 and the crimping and cutting element 40, and therefore changing the distance from the crimping and cutting element 40 to the connector 6 or the connector socket 51.

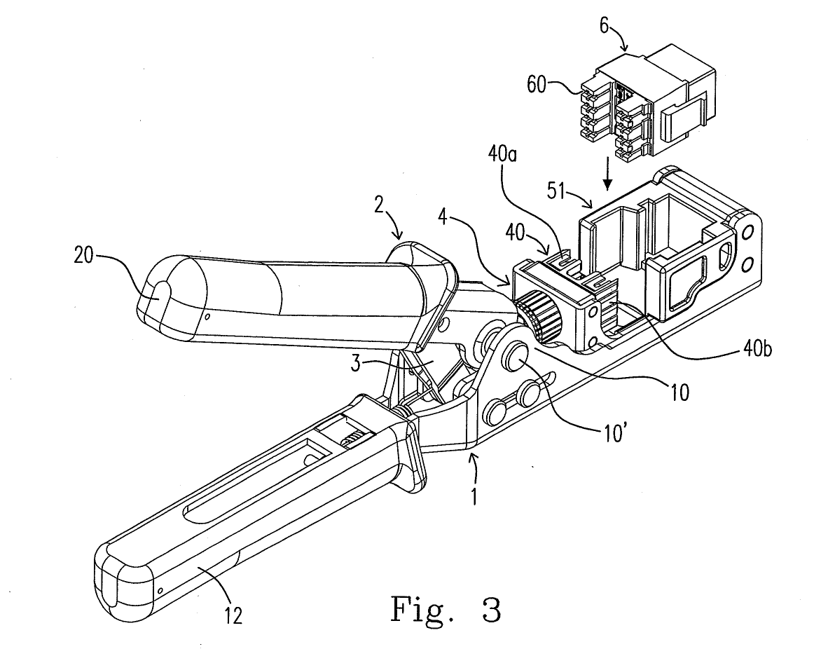

Please refer to FIG. 3, which is a schematic diagram of the cable-crimping tool for connectors, according to the preferred embodiment of the present invention shown in FIG. 1. As shown in FIG. 3, the second handle 2 is pivotally connected to the first handle 1 via the pivot portion 10 and the pivot 10′, the connecting rod 3 is located between the first handle 1 and the second handle 2, and the slider 4 is connected to the connecting rod 3 at a location under the pivot portion 10. In FIG. 3, the slider 4 is extended below the pivot 10′. When a free end 20 and a holding portion 12 approach each other, the connecting rod 3 pushes the slider 4 to let the crimping and cutting element 40 on the slider 4 approach the connector socket 51, and consequently a presser 40a in the crimping and cutting element 40 enters a IDC terminal block 60 of the connector 6. When the pressing element 40a enters the IDC terminal block 60, a conducting wire (not shown) is pressed deeply into the IDC terminal block 60 so that IDC (not shown) punctured the insulator covering the conducting wire(not shown) and connected to the network cable.

Please continue on FIG. 3, in which the component 1 may be considered as a main body 1 furnished with a connector socket 51 and a crimping and cutting element 40. The main body 1 is pivotally connected with a handle 2, which is mostly in bar shape and pivotally connected to the main body 1 at one end, and the other end thereof serves as a free end. In addition, the handle 2 is connected to the crimping and cutting element 40 via a connecting element 3 as well as a slider 4. When the handle 2 is pressed downward, the connecting element 3 is driven to push the slider 4 and move the crimping and cutting element 40 toward the connector socket 51. Eventually, the presser 40a enters the IDC terminal block 60 and allows the IDC to puncture the insulator and to be electrically connected to the conducting wire of network cable, and meanwhile a cutter 40b cuts off redundant conducting wire (not shown). Furthermore, the holding portion 12 is no longer necessary if the main body 1 is fastened on a facility, a processing platform, or a table. That is, the operator only needs to press down the handle 2 when implementing the operation of connecting the IDC to the cables. As for a hand tool, the present invention provides a handle 12 extended from the main body 1 along a direction opposite to that of the connector socket 51 and below the handle 2, i.e., at the same side of the handle 2 from the pivot portion 10's point of view, for the sake of easy handling and operation.

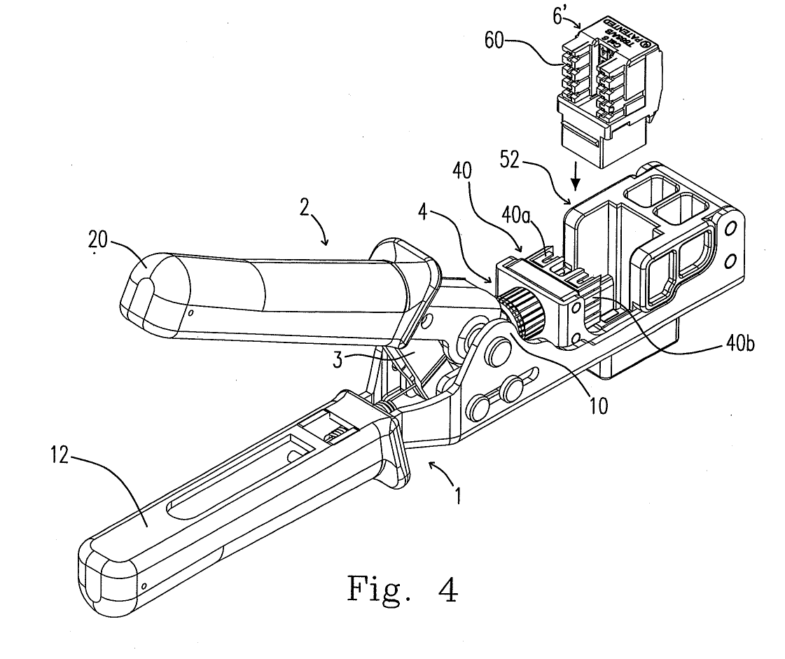

Please refer to FIG. 4, which is a schematic diagram of the cable-crimping tool for connectors, according to another preferred embodiment of the present invention, wherein the tool has a pivot portion 10 pivotally connected with a pressing rod 2. Additionally, the tool comprises a second connector socket 52 and a crimping and cutting element 40 which is located on a slider 4 and connected to a connecting rod 3. Besides, the pressing rod 2 has a free end 20. Now please refer to FIGS. 1 and 4 simultaneously, wherein the pressing rod 2 in FIG. 4 is indeed the second handle 2 in FIG. 1. A first end 31 of the connecting rod 3 is connected to the pressing rod 2, while a second end 32 of the connecting rod 3 is connected to the slider 4. Taking the pivot portion 10 as a reference position, the second connector socket 52 is located at one side of the pivot portion 10, and the free end 20 at the other side thereof.

Besides, the same as the embodiment shown in FIG. 1, the slider 4 in FIG. 4 with the crimping and cutting element 40 thereon is located on a sliding space 42, and the second connector socket 52 is located at the end of the sliding space 42. The main body 1 in FIG. 4 is also the first handle 1 in FIG. 4. Therefore the second connector socket 52 and the pivot portion 10 are located at the main body 1, and the crimping and cutting element 40 is movable on the main body 1. In addition, to allow the process of combining a connector and a cable operated by hand, the present invention further provides a hand tool in which a holding portion 12 of the main body 1 is extended from the pivot portion 10 along a direction away from the second connector socket 52 under the free end 20 of the pressing rod 2.

Since there exist a variety of types of connectors, the connector socket of the present invention is an exchangeable design. The first connector socket 51 of the first handle 1 in FIG. 1 is replaced by the second connector socket 52 in FIG. 3, to adapt the second connector 6′ in FIG. 4.

Now continue on referring to FIG. 1 and FIG. 2, in which the main portion that produces motions are the pressing rod 2, the connecting rod 3, and the slider 4 along with the crimping and cutting element 40 thereon. The present invention is to convert a rotation into a rectilinear motion as required when the connector is connected to the cable. Therefore, the pressing rod 2 is pivotally connected to a pivot portion 10 and also a connecting rod 3. A first end 31 of the connecting rod 30 is connected to the pressing rod 2, while a second end 32 thereof is connected to the crimping and cutting element 40. Consequently, the crimping and cutting element 40 performs a rectilinear motion driven by the connecting rod 3 when the pressing rod 2 is applied with external force and rotates around the pivot portion 10. In addition, the crimping and cutting element 40 usually is not connected to the connecting rod 3 directly, but is previously located on a slider 4 instead. A connector socket 51 (or 52 in FIG. 4) allowing a connector 6 to be plugged thereinto is located at a position near the end of the path in which the crimping and cutting element moves. When the pressing rod 2 is pressed to a certain position as shown in FIG. 2, the connecting rod pushes the slider 4 forward to a position such that the crimping and cutting element 40 presses a cable (not shown) into the connector 6. Besides, the crimping and cutting element 40 and the slider 4 on which the former is located slide in a sliding space 42, and the abovementioned connector socket 51 is located near the end of the sliding space 42.

Please continue on referring to FIG. 1 and FIG. 2. For the convenience of operation, the present invention provides a sliding space 42 and a pivot portion 10 at a main body 1. A crimping and cutting element 40 and a connector socket 51 are located at one side of the pivot portion 10, while a holding portion 12 of the main body 1 is extended toward an opposite direction to the connector socket 51 and under a pressing rod 2, for allowing the operator to grasp the tool of the present invention with one hand. FIG. 2 shows the situation when a free end 20 is moved downward, and the pressing rod 2 and the holding portion 12 come next to each other. At this moment, a slider 4 is pushed by a connecting rod 3 toward the connector socket 51 which makes the crimping and cutting element 40 push a cable (not shown) into a connector 6 entirely.

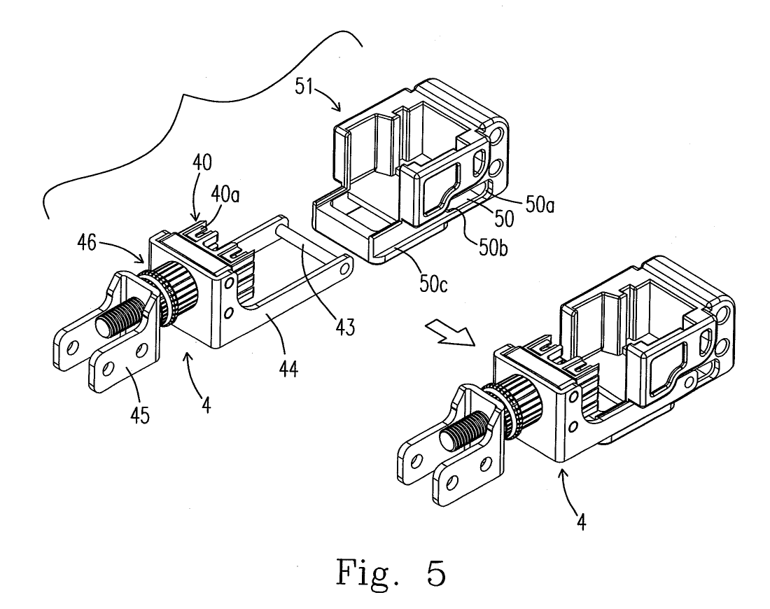

Please refer to FIG. 5, which is a pictorial diagram showing a portion of the cable-crimping tool for connectors, in accordance with the preferred embodiment of the present invention shown in FIG. 2. It is insufficient to illustrate the guiding facilities for moving forward or backward of the crimping and cutting element 40 with merely the abovementioned sliding space 42, because the crimping and cutting element 40 is nearly combined with the connector 6 after all, which means each presser 40a is to enter the corresponding IDC terminal block 60 (see FIGS. 3 and 4). To assure a precise engagement between the presser 40a and the IDC terminal block 60, the present invention further provides a constraint rod 43 at the crimping and cutting element 40 and a constraint structure 50 at the connector socket 51, in which the constraint rod 43 is restrictedly moveable in the constraint structure 50. In other words, the constraint rod 43 is moveable between an top dead center 50a and a bottom dead center 50b of the constraint structure 50. The constraint structure 50 is a hole passing through the left and right of the connector socket 51, and the dead points (50a, 50b) are located at the front and back thereof for cooperating with the movement of the slider 4. When the slider 4 is pulled backward, the constraint rod 43 is moved backward until reaching the bottom dead center 50b. On the contrary, the constraint rod 43 is moved forward until reaching the top dead center 50a when the slider 4 is pushed forward. In addition, a vertical dimension of the constraint structure 50 is about the same as the diameter of the constraint rod 43. Therefore, the constraint rod 43 is virtually constrained on vertical movement so that the presser 40a can be engaged with the corresponding conducting wire slot precisely.

Please continue on FIG. 5 along with FIG. 2. The slider 4 is extended to the constraint rod 43 via an extension arm 44, and a guiding slot 50c at the connector socket 51 is for accommodating the extension arm 44. As shown in FIGS. 5 and 2, the extension arm 44 is allowed to move back and forth in the guiding slot 50c. Along the same direction as the slider 4 moves, the extension arms 44 are connected to the two ends of the constraint rod 43 in pair. That is to say, the connector socket 51 is clamped in a pair of the constraint rods 43 whose swing on the left or right is restricted, which also keeps the crimping and cutting element 40 away form a left or right movement which may affect the connection between the presser 40a and the connector 6. Besides, the slider 4 has a tail 45 for connecting to the connecting rod 3 (see FIGS. 1-4). The adjusting screw 46 may adjust the distance between the tail 45 and the crimping and cutting element 40, to change the distance between the crimping and cutting element 40 and the connector 6, thereby accurately controlling the depth of the presser 40a entering the IDC terminal block 60 so that the issue of insufficient pressing depth can be avoided. As for the issue of over pressing on the conducting wire (not shown), it will not occur since the constraint rod 43 is constrained by the top dead center 50a.

Please refer to FIG. 5 along with FIG. 2, concerning the operation of adjusting the crimping and cutting element 40. The operation procedure is to let the free end 20 and the holding portion 12 come next to each other when there is no connector 6 in the connector socket 51, and to turn the adjusting screw 46 until the crimping and cutting element 40 is stopped because the constraint rod 43 is constrained by the top dead center 50a.

To summarize the descriptions set forth above, the present invention provides a crimping and cutting element capable of performing the connecting operations for wires and IDC simultaneously, and a cutter of the crimping and cutting element may cut off redundant conducting wires at the same time. Thus, the purposes of having a connector electrically connected with a cable as fast as possible and removing redundant conducting wires, without changing specifications of the current connectors and cables, are achieved. To assure stable processes of pressing as well as combining of wires, the present invention simplifies the force-applying process by taking advantage of the pressing rod and the connecting rod. Such a process may be performed by operating a clamp through a simple hand holding to produce an effect of moving the crimping and cutting element toward the connector, or from a mechanical point of view, by making the pressing rod rotate around the pivot portion to produce the above effect via the transmission of the connecting rod.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims that are to be accorded with the broadest interpretation so as to encompass all such modifications and similar structures.

What is claimed is:

1. A cable-crimping tool for connectors, comprising:
a connector socket having a guiding slot;
a crimping and cutting element; and
an arm connected with the crimping and cutting element, located on the guiding slot, and being movable along the guiding slot.

2. A tool as claimed in claim 1, wherein the connector socket has a constraint structure, and the arm has a stopping element constrained by the constraint structure.

3. A tool as claimed in claim 2, wherein the constraint structure is a hole for allowing the stopping element to cross therethrough, and the stopping element is connected to the arm.

4. A tool as claimed in claim 2, wherein the constraint structure has a top dead center and a bottom dead center, and the stopping element moves therebetween.

5. A tool as claimed in claim 1, further comprising:
a first handle having the connector socket;
a second handle pivotally connected with the first handle;
a pivot portion formed between the first and the second handles;
a slider located between the first and the second handles, and including the crimping and cutting element; and
a connecting rod connecting the second handle and the slider, and driving the slider to move the crimping and cutting element toward the connector socket when the first and the second handles approach to each other.

6. A tool as claimed in claim 5, wherein the slider is located below the pivot portion.

7. A tool as claimed in claim 6, wherein the first handle has a sliding space under the pivot portion for accommodating the slider.

8. A tool as claimed in claim 5, wherein the connecting rod is pivotally connected with the second handle and the slider.

9. A tool as claimed in claim 5, wherein the connecting rod is extended from a central portion of the second handle toward the pivot portion, and is connected to the slider.

10. A tool as claimed in claim 5, wherein the connector socket is exchangeable.

11. A tool as claimed in claim 5, further comprising an elastic element located between the first handle and the slider.

12. A tool as claimed in claim 1, further comprising:
a pivot portion having a first side and a second side opposite to the first side;
a pressing rod pivotally connected with the pivot portion and having a free end; and
a connecting rod having a first end connected to the crimping and cutting element, and a second end connected to the pressing rod,
wherein the connector socket is located at the first side of the pivot portion, and the free end is located at the second side of the pivot portion.

13. A tool as claimed in claim 12, wherein the crimping and cutting element is movable in a sliding space adjacent to the pivot portion and comprises a presser and a cutter.

14. A tool as claimed in claim 12, further comprising a main body, wherein the connector socket and the pivot portion are disposed at the main body, and the crimping and cutting element is disposed at the main body in a manner of allowing the crimping and cutting element to slide.

15. A tool as claimed in claim 14, wherein the main body has a holding portion under the free end of the pressing rod.

16. A cable-crimping tool for connectors, comprising:
a connector socket having a constraint structure;
a slider having a constraint element being movable in the constraint structure; and
a crimping and cutting element allocated on the slider.

17. A tool as claimed in claim 16, wherein the slider further comprises an arm extended therefrom and connected to the constraint element.

18. A tool as claimed in claim 17, wherein the connector socket has a guiding slot for accommodating the arm.

19. A cable-crimping tool for connectors, comprising:
a connector socket having a constraint structure; and
a crimping element having a constraint element in the constraint structure.

20. A tool as claimed in claim 19, wherein the constraint structure has a top dead center and a bottom dead center, and the constraint element is moved back and forth between the top dead center and the bottom dead center.
